(19) United States
(12) Patent Application Publication
(10) Pub. No.: US 2013/0151679 A1
(43) Pub. Date: Jun. 13, 2013

(54) HYBRID VIRTUAL COMPUTING ENVIRONMENTS

(71) Applicant: Kubisys Inc., New York, NY (US)

(72) Inventors: Amit Banerjee, Parsippany, NJ (US); Shinichi Urano, River Edge, NJ (US); Soubir Acharya, Pleasantville, NY (US)

(73) Assignee: Kubisys Inc., New York, NY (US)

(21) Appl. No.: 13/706,720

(22) Filed: Dec. 6, 2012

Related U.S. Application Data
(60) Provisional application No. 61/568,860, filed on Dec. 9, 2011.

(51) Int. Cl. H04L 12/24

(52) U.S. Cl. CPC H04L 41/0813; H04L 41/084
USPC 709/221; 709/220

(57) ABSTRACT

A computer-implemented method involves two phases. In a first phase (e.g., during a development or testing phase) a secondary computing environment is formed with secondary instances of one or more servers of a primary environment. A communication module configured to establish communication between the secondary instances of the servers in the secondary computing environment and remote computing resources (e.g., “cloud” based servers) via the communication module. The secondary instances of the servers of the primary environment are then operated in conjunction with the remote computing resources. In a second phase (e.g., a production phase), the communication module is reconfigured to establish communication between the servers of the primary environment and the remote computing resources via the communication module. The servers of the primary environment are then operated in conjunction with the remote computing resources.

### CROSS-REFERENCE TO RELATED APPLICATIONS

This application claims priority to U.S. Application No. 61/568,860, titled “Hybrid Virtual Computing Environments,” filed on Dec. 9, 2011, which is incorporated herein by reference.

This application is related to U.S. application Ser. No. 12/138,574, titled “Virtual Computing Environment,” filed on Jun. 13, 2008, and published as U.S. Pat. Pub. 2009/0106256A1 on Apr. 23, 2009, which is incorporated herein by reference.

### BACKGROUND

This invention relates to hybrid virtual computing environments.

The prior application, “Virtual Computing Environment,” which is incorporated by reference describes one or more approaches in which a virtual or “shadow” environment duplicates one or more servers in an enterprise, for example, for purposes of testing.

One area of system testing that has proven difficult relates to distributed systems in which one or more servers are at one location, for example, a user's premises, to be configured to make use of other remote server resources, for example, providing a “cloud” service. Integration of such remote servers into a production system can be error prone, and therefore, robust testing of such a configuration is needed prior to use of the distributed system in production.

### SUMMARY

In a general aspect, a computer-implemented method (e.g., performed by a machine executing instructions stored on a machine-readable medium) involves two phases. In a first phase (e.g., during a development or testing phase), a secondary computing environment is formed with secondary instances of one or more servers of a primary environment. A communication module is configured to establish communication between the secondary instances of the servers in the secondary computing environment and remote computing resources (e.g., “cloud” based servers) via the communication module. The secondary instances of the servers of the primary environment are then operated in conjunction with the remote computing resources. In a second phase (e.g., a production phase), the communication module is reconfigured to establish communication between the servers of the primary environment and the remote computing resources via the communication module. The servers of the primary environment are then operated in conjunction with the remote computing resources.

Aspects may include one or more of the following features.

Forming the secondary computing environment comprises duplicating configuration information from the primary environment, and configuring the communication module to provide access to at least some local computing resources of the primary environment.

Forming the secondary computing environment comprises configuring a virtual server as a duplicate of a physical server of the primary environment.

Establishing communication between the secondary instances of the servers in the secondary computing environment and remote computing resources includes setting up a secure communication channel between an interface of the communication module and an interface of the remote computing resources.

The interface of the communication module comprises a virtual private network interface.

The interface of the communication module is provided by a virtual firewall of a virtual network of the secondary computing environment.

Establishing communication between the secondary instances of the servers in the secondary computing environment and remote computing resources includes setting up a communication channel between an interface of the communication module and an interface of the remote computing resources over a first path through a first gateway of the primary environment.

Reconfiguring the communication module comprises configuring the interface of the communication module as a second gateway between the servers of the primary environment and the interface of the remote computing resources, and re-routing the communication channel over a second path through the second gateway.

Reconfiguring the communication module comprises adding an additional route rule to a network address translation table.

Reconfiguring the communication module comprises configuring the interface of the communication module as a second gateway between the servers of the primary environment and the first gateway, and re-routing the communication channel over a second path through the second gateway and the first gateway.

In another aspect, in general, a computing sub-system (e.g., a self-contained “appliance”) includes a network interface for coupling the sub-system to a local network and computing resources for hosting secondary instances of one or more server computers. The sub-system also includes a communication module configurable to (a) provide a communication gateway for secondary instances of the servers to communicate with remote computing resources, and (b) provide a communication gateway for primary instances to communicate with the remote computing resources through the network interface. A controller is used for establishing the secondary instances of the server computers and configuring the communication module such that the primary instances of the server computers are presented with the same communication gateway to the remote computing resources as is presented to the secondary instances of the servers.

Aspects may include one or more of the following features.

Hosting the secondary instances comprises duplicating configuration information for the one or more server computers, and configuring the communication module to provide access to at least some local computing resources of the one or more server computers.

Hosting the secondary instances comprises configuring virtual servers as duplicates of the one or more server computers.

Providing the communication gateway for the secondary instances of the servers to communicate with the remote computing resources includes setting up a secure communication channel between an interface of the communication module and an interface of the remote computing resources.

The interface of the communication module comprises a virtual private network interface.

The interface of the communication module is provided by a virtual firewall of a virtual network of the secondary instances.

Providing the communication gateway for the secondary instances of the servers to communicate with the remote computing resources includes setting up a communication channel between an interface of the communication module and an interface of the remote computing resources over a first path through a first gateway.

Configuring the communication module such that the primary instances of the server computers are presented with the same communication gateway to the remote computing resources as is presented to the secondary instances of the servers comprises: configuring the interface of the communication module as a second gateway between the one or more server computers and the interface of the remote computing resources, and re-routing the communication channel over a second path through the second gateway.

Configuring the communication module such that the primary instances of the server computers are presented with the same communication gateway to the remote computing resources as is presented to the secondary instances of the servers comprises: adding an additional route rule to a network address translation table.

Configuring the communication module such that the primary instances of the server computers are presented with the same communication gateway to the remote computing resources as is presented to the secondary instances of the servers comprises: configuring the interface of the communication module as a second gateway between the servers of the primary environment and the first gateway, and re-routing the communication channel over a second path through the second gateway and the first gateway.

Aspects may have one or more of the following advantages.

Easy experimental extension of a current computing infrastructure to cloud resources is enabled.

The mechanism is capable to extend both secondary instances of servers as well as primary instances in an in-house production infrastructure.

When a secondary (“shadow”) network is extended, it gives the full freedom to experiment. Users are capable of experimenting with the changes required in the application stack to extend communication to the cloud and later the same steps can be repeated in a production system to extend the actual infrastructure.

A secure and encrypted data channel is provided between the cloud and existing IT infrastructure.

In most of the cases there is no change required in a gateway linking the production local network to the wide area network (e.g., Internet) to reach the remote computing resources.

Inter-domain routing (e.g., CIDR) on the cloud can be chosen by a user, looking at its existing subnets. It gives a user complete control to segregate resources in the cloud from an existing network.

Rapid creation of the shadow environment with cloud extensions (e.g., in less than 20 minutes) permits repeated testing and creation of multiple test environments prior to deploying a production system.

### DESCRIPTION OF DRAWINGS

FIGS. 1A-B are a diagram of a computing environment.

FIG. 2 is a diagram of an example use scenario.

### DESCRIPTION

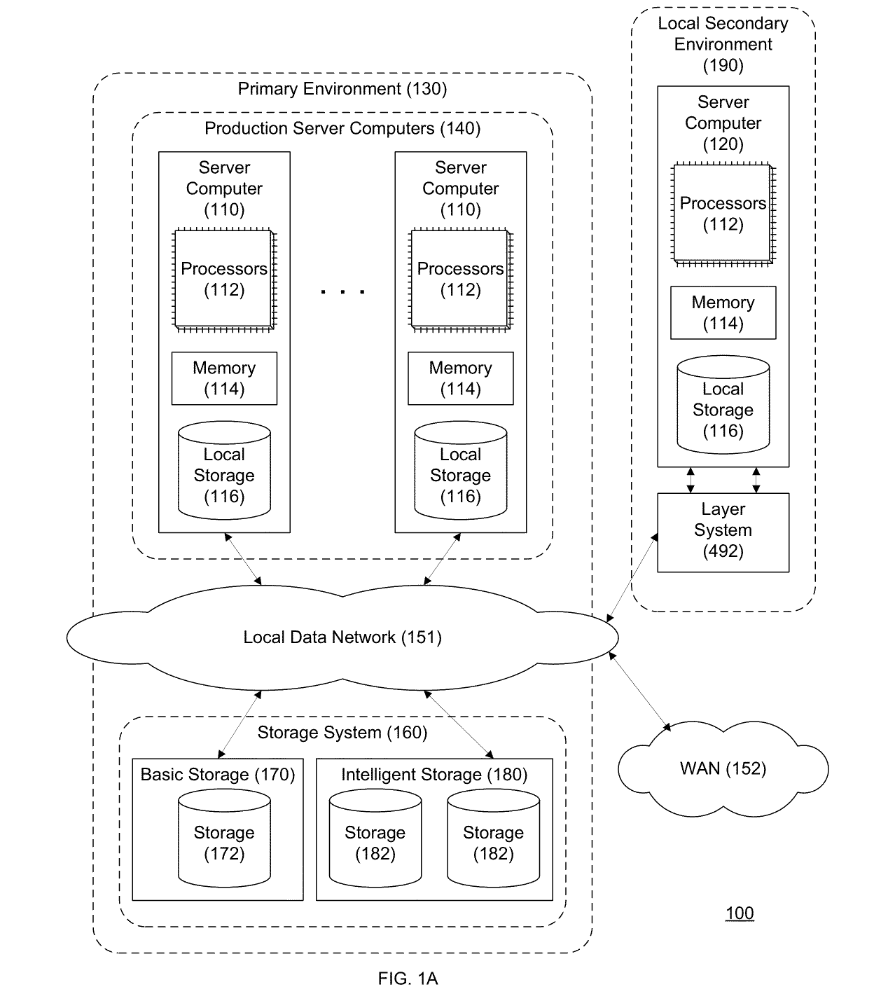

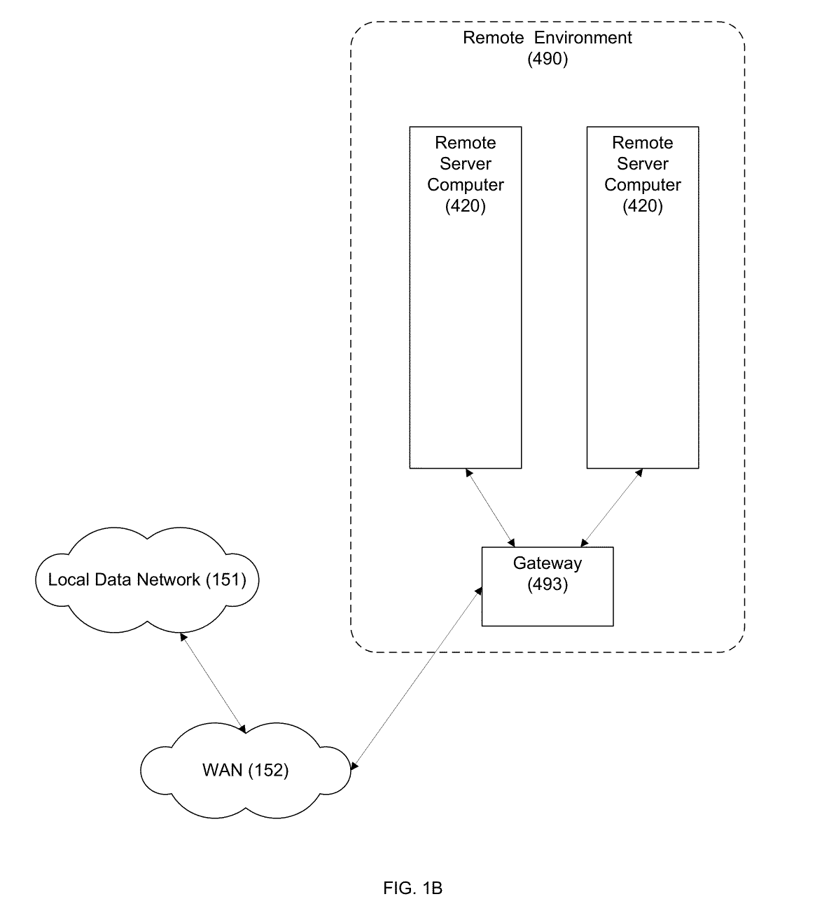

FIG. 1 of the related U.S. Pat. Pub 2009/0106256A1 “Virtual Computing Environment,” shows a computing environment that includes a number of server computers, which are collectively referred to as a production servers, that are linked by a data network. A secondary environment is used to host duplicate (“shadow”) instances of some of the production servers as described in that application.

Referring to FIG. 1A of the present application, one implementation of such shadow environment is as an “appliance,” which is a self-contained computer or set of computers that connect to the user's local environment that includes a premised local data network 151. Functionally, this appliance hosts a local secondary environment 190. This environment 190 includes one or more physical and/or virtual server computers 120, each having a processor 112, memory 114, and physically or logically having local storage 116.

The user's local environment includes a primary environment 130, which includes one or more production server computers 140 coupled to the local data network 151, and a storage system 160 coupled to the local data network 151. One function of the appliance (as a shadow appliance) is to capture shadow instances of a number of the server computers 110 of the production environment, and set up a shadow environment containing the shadow instances of these computers (also called “shadow servers”) in the secondary environment 190 hosted on the physical or virtual computers 120. In some examples, this setting up of the shadow environment is very quick, for example, taking less than 15 minutes.

This set of shadow instances of the production servers that are hosted on the physical or virtual computers 120 are encapsulated in the appliance, and are functionally identical to the set of production server computers 140 with the capability to communicate over a virtual network with each other and with the production network via a virtual firewall that is part of the shadow environment. The IP addresses, MAC addresses, and other data related to the network configuration is captured accurately as well and preserved in the shadow environment. This virtual network is fenced off and has very restricted communication to the outside through a virtual firewall. This virtual network is referred to herein as the shadow network.

By creating an encapsulated identical set of virtual machines, which can communicate with each other as a point in time image (snapshots) of the enterprise, which can be modified freely without impacting the originals, and discarded at will, a wide variety of enterprise testing may be accomplished. One can for instance make software and configuration changes to shadow servers inside the appliance (without affecting production), examine the impact of these changes, repeat or revert and so on.

The facilities of a local shadow appliance are particularly useful in the case of testing a configuration that involves remote (e.g., cloud) resources. Referring to FIG. 1B, in a first use scenario, a remote environment 490 includes a number of physical or remote servers 420. In some examples, these servers are private in that they are only accessible to the user over a virtual local network, while in other examples, the servers have a public interface, for example, providing a web services, electronic commerce, or other application interface to outside users. In the case of servers that have a public interface, a mechanism that is not described below is used to enable public access to the servers, for example, by modifying a configuration of a load management system, a domain name service (DNS) system, etc.

The remote environment 490 includes a remote gateway 493, through which communication to the user's premised local data network 151 is passed. In this use case, this remote gateway 493 establishes a communication path over a wide area network (WAN) 152 (e.g., the Internet) to a communication component of the shadow environment provided by the appliance. In production, this appliance provides a local gateway to a production environment, such as the primary environment 130, over the premised local data network 151. During testing of a shadow environment, the appliance provides a local gateway to the shadow environment, such as the secondary environment 190.

Generally, one scenario for integrating cloud based services into the production environment follows the following steps:

First, remote environment 490 is established, including the remote server computers 420, and the remote gateway 493. These computers 420 are the instances of the remote computers that will be used in testing using the local shadow environment, and will also be the servers that are then used after testing when the production environment is configured to use them.

Next, the local secondary environment 190 is established. The shadow instances of the production servers include at least those servers that will interact with the remote computers 420. A layer system 492 is configured to connect to the remote gateway 493, and to give the shadow computers access to the remote computers, without exposing the remote computers to the production environment.

The combination of the local shadow environment and the remote environment are then tested, without concern that the testing can affect the production environment.

Finally, once the testing of the shadow and remote environments is complete, the production servers are configured in substantially the same manner as were the shadow instances of those production servers. In order to provide the same communication interfaces (e.g., addresses, gateways, network characteristics) as were presented to the shadow servers, the appliance is automatically reconfigured to provide an interface to the remote computers from the production servers. This automatic switching of the communication avoids a potentially error-prone reconfiguration of network edge devices, virtual private network adapters, etc. when moving to the production phase. The configurations of the relevant network components have already been tested with the shadow environment.

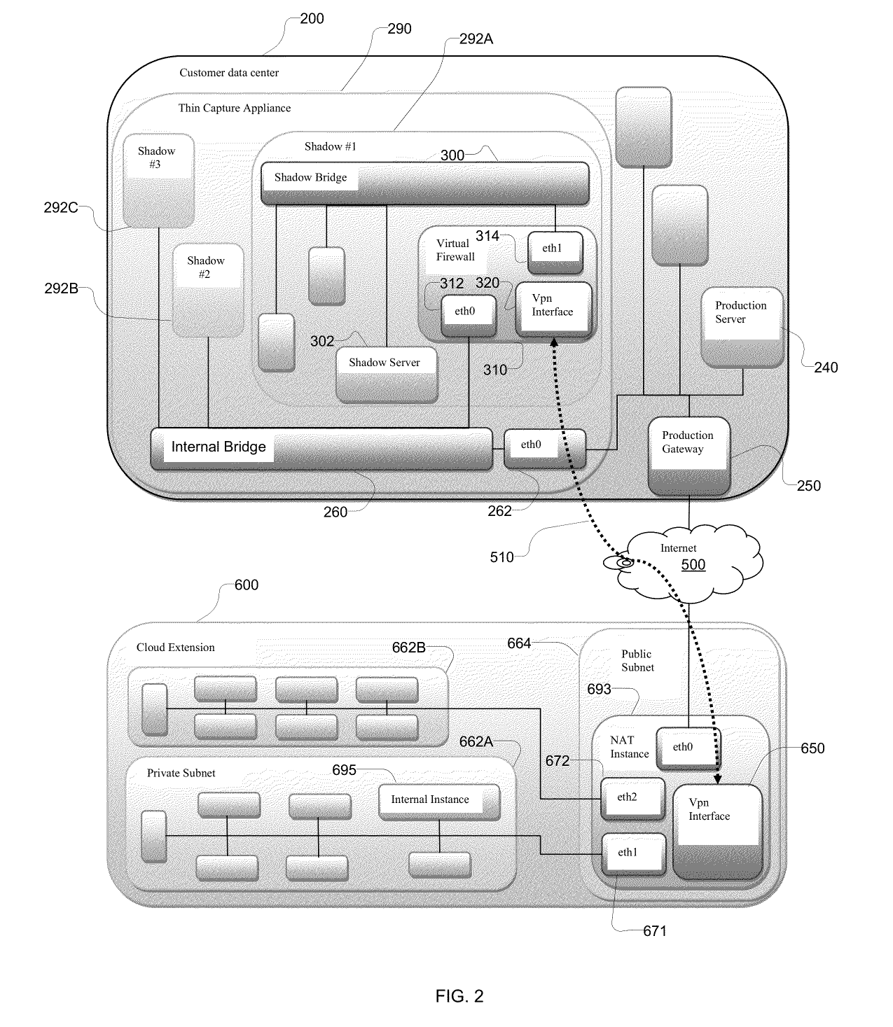

Referring to FIG. 2, an example of the approach described above is described below in more detail. In this example, the shadow appliance described above is referred to as a “thin capture appliance.” In this example, a customer data center 200 includes a local production network, including a production server 240 (and optionally other servers), coupled to a production gateway 250. The production network also couples a thin capture appliance 290 to the production gateway 250. The thin capture appliance 290 includes an internal bridge 260 that is coupled over a port 262 to the production gateway 250. The internal bridge 260 supports multiple shadow networks 292A-292C, with one of the shadow networks being a currently active shadow network 292A. To set up the active shadow network 292A, the thin capture appliance 290 forms a shadow bridge 320 that connects shadow servers that represent virtual duplicates of the servers of the production network, including a shadow server 302 that is a duplicate of the production server 240. The thin capture appliance 290 also sets up a virtual firewall 310 that includes a port 312 connected to the internal bridge 260, and a port 314 connected to the shadow bridge 300. The thin capture appliance 290 starts running the shadow servers after starting the virtual firewall. After the shadow servers have started up, the shadow network 292A is ready to be extended to the cloud.

The production gateway 250 is coupled over the Internet 500 to a cloud extension environment 600. Two types of network segments are included within the cloud extension environment 600. One type of network segment is a public subnet 664, and another type of network segment is a private subnet. Multiple private subnets may be included in the cloud extension environment 600. In this example, a first private subnet 662A is coupled over a port 671 to the public subnet 664, and a second private subnet 662B is coupled over a port 672 to the public subnet 664. In this example, remote servers provided within the cloud extension environment 600 are instantiated in private subnets. These remote servers are connected among themselves over the private subnet, and are optionally configured to reach the Internet 500. In this example, these remote servers include server instances, referred to as ‘internal instances’, which are configured to be accessible to the customer data center 200 from within the cloud extension environment 600 through the public subnet 664. The internal instances can be configured, for example, to extend an existing application stack of the customer data center 200 to the cloud extension environment 600. The internal instances can be configured to operate using any of a variety of operating systems (e.g., Linux, or Windows), and different internal instances can use different operating systems.

There is a server configured as a network address translation (NAT) enabled router, called a NAT instance 693, included in the public subnet 664. This NAT instance 693 is capable of communicating with the internal instances through an interface that uses network address translation. The NAT instance 693 has a VPN server installed. This VPN server is configured to create an encrypted secure VPN channel 510 over the Internet 500 (using an Internet Protocol channel) between a VPN interface 320 of the virtual firewall 310 and a VPN interface 650 of the NAT instance 693. For example, the VPN server installed in the NAT instance 693 uses a pptpd server, which creates an encrypted PPP channel over IP.

The NAT instance 693 is assigned a public IP address, so that it is reachable from anywhere over the Internet 500. A network ACL (access control list) on the public subnet 664 can restrict source IP addresses (e.g., to the production gateway 250 of the customer data center 200). Access to the NAT instance 693 of the public subnet 664 from outside the cloud extension environment 600 (e.g., from the Internet 500) is restricted to secure communication over the VPN interface 650.

The customer data center 200 is able to initiate the encrypted VPN channel 510 from the thin capture appliance 290 to the NAT instance 693. Channel creation uses the public IP address of the NAT instance and the VPN interfaces 320, 650. After the VPN channel 510 is created, the shadow server 302 is able to communicate with the internal instance 695 in the cloud extension environment 600 through the secure VPN channel 510, for example, in a testing phase.

After the testing phase, in a production phase, a user is able to reconfigure the thin capture appliance 290 to establish communication between the production server 240 and the same internal instance 695. For example, the user can configure the VPN interface 320 and the production server 240 to add one additional route rule to use the thin capture appliance 290 as a gateway for routing packets between the production server 240 and the cloud extension environment 600 over the same VPN channel 510, without necessarily having to re-establish a secure communication channel.

In this example, multiple shadow networks are able to co-exist in the appliance 290 but only one shadow network can have an active channel coupled to the cloud extension environment 600 at one time. Also, in this example, the active shadow network 292A and the production network can't connect to the cloud extension environment 600 simultaneously. Other examples may have other capabilities and/or restrictions.

It is to be understood that the foregoing description is intended to illustrate and not to limit the scope of the invention, which is defined by the scope of the appended claims. Other embodiments are within the scope of the following claims.

What is claimed is:

1. A computer-implemented method comprising:
in a first phase,
forming a secondary computing environment comprising secondary instances of one or more servers of a primary environment,
configuring a communication module to establish communication between the secondary instances of the servers in the secondary computing environment and remote computing resources via the communication module, and
operating the secondary instances of the servers of the primary environment in conjunction with the remote computing resources; and
in a second phase,
reconfiguring the communication module to establish communication between the servers of the primary environment and the remote computing resources via the communication module;
operating the servers of the primary environment in conjunction with the remote computing resources.

2. The computer-implemented method of claim 1, wherein forming the secondary computing environment comprises duplicating configuration information from the primary environment, and configuring the communication module to provide access to at least some local computing resources of the primary environment.

3. The computer-implemented method of claim 1, wherein forming the secondary computing environment comprises configuring a virtual server as a duplicate of a physical server of the primary environment.

4. The computer-implemented method of claim 1, wherein establishing communication between the secondary instances of the servers in the secondary computing environment and remote computing resources includes setting up a secure communication channel between an interface of the communication module and an interface of the remote computing resources.

5. The computer-implemented method of claim 4, wherein the interface of the communication module comprises a virtual private network interface.

6. The computer-implemented method of claim 4, wherein the interface of the communication module is provided by a virtual firewall of a virtual network of the secondary computing environment.

7. The computer-implemented method of claim 1, wherein establishing communication between the secondary instances of the servers in the secondary computing environment and remote computing resources includes setting up a communication channel between an interface of the communication module and an interface of the remote computing resources over a first path through a first gateway of the primary environment.

8. The computer-implemented method of claim 7, wherein reconfiguring the communication module comprises configuring the interface of the communication module as a second gateway between the servers of the primary environment and the interface of the remote computing resources, and re-routing the communication channel over a second path through the second gateway.

9. The computer-implemented method of claim 8, wherein reconfiguring the communication module comprises adding an additional route rule to a network address translation table.

10. The computer-implemented method of claim 7, wherein reconfiguring the communication module comprises configuring the interface of the communication module as a second gateway between the servers of the primary environment and the first gateway, and re-routing the communication channel over a second path through the second gateway and the first gateway.

11. A machine-readable medium that stores executable instructions to cause a machine to:
in a first phase,
form a secondary computing environment comprising secondary instances of one or more servers of a primary environment,
configure a communication module to establish communication between the secondary instances of the servers in the secondary computing environment and remote computing resources via the communication module, and
operate the secondary instances of the servers of the primary environment in conjunction with the remote computing resources; and
in a second phase,
reconfigure the communication module to establish communication between the servers of the primary environment and the remote computing resources via the communication module;
operate the servers of the primary environment in conjunction with the remote computing resources.

12. The machine-readable medium of claim 11, wherein forming the secondary computing environment comprises duplicating configuration information from the primary environment, and configuring the communication module to provide access to at least some local computing resources of the primary environment.

13. The machine-readable medium of claim 11, wherein forming the secondary computing environment comprises configuring a virtual server as a duplicate of a physical server of the primary environment.

14. The machine-readable medium of claim 11, wherein establishing communication between the secondary instances of the servers in the secondary computing environment and remote computing resources includes setting up a secure communication channel between an interface of the communication module and an interface of the remote computing resources.

15. The machine-readable medium of claim 14, wherein the interface of the communication module comprises a virtual private network interface.

16. The machine-readable medium of claim 14, wherein the interface of the communication module is provided by a virtual firewall of a virtual network of the secondary computing environment.

17. The machine-readable medium of claim 11, wherein establishing communication between the secondary instances of the servers in the secondary computing environment and remote computing resources includes setting up a communication channel between an interface of the communication module and an interface of the remote computing resources over a first path through a first gateway of the primary environment.

18. The machine-readable medium of claim 17, wherein reconfiguring the communication module comprises configuring the interface of the communication module as a second gateway between the servers of the primary environment and the interface of the remote computing resources, and re-routing the communication channel over a second path through the second gateway.

19. The machine-readable medium of claim 18, wherein reconfiguring the communication module comprises adding an additional route rule to a network address translation table.

20. The machine-readable medium of claim 17, wherein reconfiguring the communication module comprises configuring the interface of the communication module as a second gateway between the servers of the primary environment and the first gateway, and re-routing the communication channel over a second path through the second gateway and the first gateway.

21. A computing sub-system comprising:
a network interface for coupling the sub-system to a local network;
computing resources for hosting secondary instances of one or more server computers;
a communication module configurable to (a) provide a communication gateway for secondary instances of the servers to communicate with remote computing resources, and (b) provide a communication gateway for primary instances to communicate with the remote computing resources through the network interface;
a controller for establishing the secondary instances of the server computers and configuring the communication module such that the primary instances of the server computers are presented with the same communication gateway to the remote computing resources as is presented to the secondary instances of the servers.

22. The computing sub-system of claim 21, wherein hosting the secondary instances comprises duplicating configuration information for the one or more server computers, and configuring the communication module to provide access to at least some local computing resources of the one or more server computers.

23. The computing sub-system of claim 21, wherein hosting the secondary instances comprises configuring virtual servers as duplicates of the one or more server computers.

24. The computing sub-system of claim 21, wherein providing the communication gateway for the secondary instances of the servers to communicate with the remote computing resources includes setting up a secure communication channel between an interface of the communication module and an interface of the remote computing resources.

25. The computing sub-system of claim 24, wherein the interface of the communication module comprises a virtual private network interface.

26. The computing sub-system of claim 24, wherein the interface of the communication module is provided by a virtual firewall of a virtual network of the secondary instances.

27. The computing sub-system of claim 21, wherein providing the communication gateway for the secondary instances of the servers to communicate with the remote computing resources includes setting up a communication channel between an interface of the communication module and an interface of the remote computing resources over a first path through a first gateway.

28. The computing sub-system of claim 27 wherein configuring the communication module such that the primary instances of the server computers are presented with the same communication gateway to the remote computing resources as is presented to the secondary instances of the servers comprises: configuring the interface of the communication module as a second gateway between the one or more server computers and the interface of the remote computing resources, and re-routing the communication channel over a second path through the second gateway.

29. The computing sub-system of claim 28, wherein configuring the communication module such that the primary instances of the server computers are presented with the same communication gateway to the remote computing resources as is presented to the secondary instances of the servers comprises: adding an additional route rule to a network address translation table.

30. The computing sub-system of claim 27, wherein configuring the communication module such that the primary instances of the server computers are presented with the same communication gateway to the remote computing resources as is presented to the secondary instances of the servers comprises: configuring the interface of the communication module as a second gateway between the servers of the primary environment and the first gateway, and re-routing the communication channel over a second path through the second gateway and the first gateway.
